(19) United States
(12) Patent Application Publication
(10) Pub. No.: US 2014/0351115 A1
(43) Pub. Date: Nov. 27, 2014

(54) LOAN COMPLIANCE SYSTEM

(71) Applicant: Sanjeevkumar V. Dahiwadkar, Ellicott City, MD (US)

(72) Inventor: Sanjeevkumar V. Dahiwadkar, Ellicott City, MD (US)

(21) Appl. No.: 14/331,834

(22) Filed: Jul. 15, 2014

Related U.S. Application Data
(63) Continuation-in-part of application No. 12/589,755, filed on Oct. 28, 2009.

(51) Int. Cl. G06Q 40/02

(52) U.S. Cl. CPC G06Q 40/025
USPC 705/38

(57) ABSTRACT

A software method and utility for business practice management based on a prescribed workflow with defined interactions between the users of the system, the clients of the business practice, and information relating to the clients or assets of the business practice. The system facilitates management of assets and human resources, including employees, client accounts, inventory, and records using a modular approach.

### CROSS-REFERENCE TO RELATED APPLICATION(S)

The present application is a continuation-in-part of U.S. application Ser. No. 12/589,755 filed Oct. 28, 2009.

### BACKGROUND OF THE INVENTION

1. Field of the Invention

The present invention relates to computerized communications platforms and, more particularly, to a loan complaince platform that can be used by servicers, third-party due diligence firms, investors, insurers and regulators to perform servicing audits focused on compliance with standards, requirements, and regulations.

2. Description of the Background

There are many parties involved in servicing debt, including the borrower, loan servicer(s), lender, guarantor/insurer, and other vendors or third-party providers. All of these parties collaborate in resolving delinquent loans, and each action or bit of information generated from the process may affect the economic consequences to the other parties. Despite the clear need for coordination loan servicing remains a fragmented, labor intensive, non-integrated process, subject to a constantly evolving body of federal and state regulations. Few loan servicers can ensure one hundred percent compliance with current guidelines. There is clearly a great need for a computer platform that is easily accessible by the various parties to a loan and that facilitates information gathering, integration, and analysis for all affected parties.

Various software solutions exist for managing various aspects of various types of business practices, including inventory, employees, client accounts, and records. Most of these solutions are task-specific. Consequently, practice managers must compile a collection of different software packages, and a number of expensive, inadequate, mismatched tools that quickly become obsolete. Global practice management is a more difficult task. Examples include:

U.S. Pat. No. 8,386,288 to Ananian et al. shows a generic workflow management system used to manage workflow within a single organization. When one user drops an object (e.g., a document) into a drop-box application program it causes a workflow engine to generate and send a workflow package to another user's drop-box application, the package including a plurality of workflow tasks, workflow rules, schedules, etc. to be implemented by the second user.

U.S. Pat. No. 4,503,499 to Mason et al. (Eaton) issued Mar. 5, 1985 shows a controlled work flow system that is a basic document/project collaboration platform with schedules of tasks associated with each document, inclusive of tasks to be performed on the document, the individual who is to perform the task, whether the task has been completed, whether the task must await the completion of a preceding task identified in the data packet in the schedule and, if so, which preceding data packets have tasks which must be first completed.

United States Patent Application 20110167007 by Saitta published Jul. 7, 2011 shows a system and method for managing the delegation of tasks that provides real-time oversight, workflow compliance and business rule compliance of individual or groups of tasks. A first party can create a task and assign the task to a second party, whereby the second party can review the task, respond to the task, and accept the task. A workflow engine ensures that processes for creating, assigning, reviewing, responding to, or accepting the task are performed in accordance with a predefined workflow.

United States Patent Application 20050278246 by Friedman et al. published Dec. 15, 2005 shows a software solution management of problem loans that guides communications among a Mortgage Servicer, Borrower, Guarantor/insurer, and Third-Party Provider.

U.S. Pat. No. 7,685,008 to McGiffin et al. (Accenture) issued Mar. 23, 2010 shows an account management system for managing an underwriting account that establishes a plurality of participants, assigns each participant to an account, establishes business rules at an account level, and provides an underwriting decision for an account based upon the business rules.

U.S. Pat. No. 7,966,256 to Liao et al. (Corelogic Information Solutions, Inc.) issued Jun. 21, 2011 shows a method and system of predicting mortgage payment risk of payment default.

U.S. Pat. No. 6,904,412 to Broadbent et al. (EverBank) issued Jun. 7, 2005 shows an automated compliance solution that uses the Federal, State, local and professional regulations and requirements and implementing instructions to generate a plurality of tasks which can be used to control and drive the process of handling a mortgage loan application to completion and to monitor the completion of the tasks in order to generate a Completion Certificate.

United States Patent Application 20100241556 by Reinheimer et al. published Sep. 23, 2010 shows a computer-implemented system and method for mortgage lending management and compliance that automatically determines if a loan complies with legal requirements and/or requires counseling.

United States Patent Application 20120271756 by Saitta published Oct. 25, 2012 shows a decision engine that imports and analyzes asset data, uses modeling to predict a plurality of possible strategies based on the data, and selects an optimal strategy from the plurality of possible strategies.

United States Patent Application 20110258101 by Albertelli et al. (PREO, LLC) published Oct. 20, 2011 discloses a method of loss mitigation and disposal of real estate related assets, which manages short sales. The system includes a Lender portal for tracking and analyzing of every step of the loss mitigation, finance and disposition process for non-performing real estate assets, and comparing all of the loss mitigation methods employed and to determine the most financially successful of those methods.

United States Patent Application 20110258101 by Albertelli et al. (above) which discloses a method of loss mitigation.

U.S. Pat. No. 8,015,091 to Ellis (Clayton Fixed Income Services, Inc.) issued Sep. 6, 2011 shows a solution for analyzing loan data to identify risk that allows a user to apply one or more risk filters to the loan data to identify particular loans with particular risk characteristics. The system further includes a loss estimation engine for providing an estimated loss for each loan, a probability of loss engine for determining a probability of loss for each loan, and a loss list engine for generating a list of loans with heightened risk of loss.

U.S. Pat. No. 5,930,775 to McCauley et al. (Freddie Mac) issued Jul. 27, 1999 shows a solution for loss mitigation for distressed residential real estate loans. The system collects loan data including personal data relating to a borrower, financial information relating to the borrower's financial position, and loan conditions including a loan term and information on the corresponding real estate. The system then generates a comparison model including an ability-to-pay rate, a default rate reflecting an interest rate realizable if the loan is foreclosed, and a short sale rate. Using a relationship determined from the ability-to-pay rate, the default rate, and the short sale rate, the system selects the optimal solution for the loan.

U.S. Pat. No. 8,244,572 to Jackson et al. (OneDemand.com) issued Aug. 14, 2012 shows a system and method for managing foreclosure actions that facilitates simultaneous dialogs between legal process managers and networked attorneys and contractors. The legal process managers submit queries and deadlines selected to timely guide the attorneys and contractors through the requirements of the foreclosure.

U.S. Pat. No. 7,624,067 to Hargrave et al. issued Nov. 24, 2009 shows a bankruptcy creditor manager internet system with secured access for bankruptcy counsel and creditors.

United States Patent Application 20100191660 by Burr et al. (Sierra Case Management Services, LLC) published Jul. 29, 2010 shows a system for managing bankruptcy cases which includes an interface for a user to access at least one computer program for managing the bankruptcy case and a database to electronically store bankruptcy case data.

United States Patent Application 20130018808 by Schwartz et al. (Caseact LLC) published Jan. 17, 2013 shows a workflow management solution for eviction case management where copies of court documents associated with the eviction, corresponding schedules, and electronic case information is provided over the Internet. The actions due are tracked for completion, and alert(s) representing that at least one of the one or more actions is coming due or is past due are transmitted to a party associated with the case.

United States Patent Application 20120173439 by Levy published Jul. 5, 2012 is very similar to the '8808 application by Schwartz et al. and provides a workflow which prompts landlords and attorneys with respect to decision points in the processing of the action for eviction, and assists the landlord and attorneys with data collection, form entry, document production, official filings, and other steps necessary in order to move through the decision tree and successfully carry out the action.

U.S. Pat. No. 8,055,529 to Jackson et al. issued Nov. 8, 2011 shows a system and method for assessing attorney performance in prosecuting security interest enforcement actions.

United States Patent Application 20040243508 by Samson et al. published Dec. 2, 2004 shows a system and method for automating credit counseling and debt management that manages a high volume of credit counseling agencies' work, stores flexible rules and relationships between creditors and clients, and automatically implement rules. The system assigns various groups of tasks to various modules, including a contact module, appointment schedule module, counseling module, creditor management module, etc.

U.S. Pat. No. 7,707,055 (Altisource Solutions S.A.R.L) to Behmoiras et al. issued Apr. 27, 2010 shows a vendor management solution that allows a financial institution to manage the transactions of a vendor. Qualitative performance analysis functionality allows an end user to monitor and evaluate a vendor's price, turn-around time, quality score, and overall score.

U.S. Pat. No. 7,523,066 to Beggins et al. (GE Capital Corp.) issued Apr. 21, 2009 shows a workflow solution for use by trustees, investors, borrowers, and other vendors associated with a commercial mortgage loan, that provides a portal to borrowers and investors which lets them access information regarding a commercial mortgage loan account, submit a request for a vendor service, and which identifies a vendor to provide the service. The system communicates the request to said vendor and tracks workflow on the request. Vendors may include accounting firms, law firms, property inspectors, property appraisers, banks or other financial institutions, etc. This patent also provides order creation, receipt and data exchange for mortgage-related services such as Title Search, AVM, BPO, Bankruptcy checks, and skip tracing. Many of the claims require processing inquiries from investors (mortgage owners). When one is received, the system looks up all investors (mortgage owners) associated with that mortgage and the response to the inquiry is sent to all of them.

Despite the foregoing, there is presently a great need for a system that is easily accessible by the various parties that facilitates information gathering, integration, and analysis, and regulatory-compliant loan servicing that mitigates losses to all effected parties.

What is needed is a business practice management system that manages the foregoing in an integrated fashion, has the flexibility to be implemented with a wide variety of other business practices such as default-loan servicing and healthcare, is easily adaptable to changes in needs of business practices, and can be delivered to the business practice without requiring investment in equipment or products. The present invention fulfills these needs by providing features, applications and services focused toward just these tasks.

### SUMMARY OF THE INVENTION

Accordingly, it is an object of the invention to provide a web-based business practice management system based on a prescribed workflow with defined interactions between the users of the system. The practice management system brings together various participants involved in management of a business, facilitates communication and imposes a prescribed workflow with defined interactions between the participants.

The practice management system comprises a hierarchy of software modules deployed on a distributed client server hardware platform via dedicated web portals for each of the particular participants. The modules are selectively made available to participants based on permissions, and the modules collectively provide each participant all the essential tools to manage their workflow. The practice management system specifically provides the following capabilities:
Case Management and Work Flow Management
Phone Log & Diary (Notes)
Reports & Charts
Document Generation
Secure Messaging, Email, Fax
Role based security
Data exchange using “open architecture” format and methods
Reports of decision critical information.
Day-to-day work scheduling, tracking, etc.
Integration with standard business softwares.
Algorithmic work-distribution support
Information exposure is controlled based on the “need to know” basis.
Detailed Audit trail of all the actions taken in the application by all the users.
Template-based, AutoFill Document Generation suitable for legal filing with precise margin control

For a more complete understanding of the invention, its objects and advantages, refer to the remaining specification and to the accompanying drawings.

### BRIEF DESCRIPTION OF THE DRAWINGS

Other objects, features, and advantages of the present invention will become more apparent from the following detailed description of the preferred embodiment and certain modifications thereof, in which:

FIG. 1 illustrates the various participants involved in default loan servicing practice management

FIG. 2 is an illustration of the harware architecture which is a distributed hub-and-spoke client server hardware architecture.

FIG. 3 is a more detailed schematic diagram of the software architecture, including architecture and communication flow.

FIG. 4 is an itemization of the different sub-modules of the Business Process Module required for the legal forclosure-oriented practice.

FIG. 5 is a screenshot of an exemplary operational dashboard available to the various participants.

FIG. 6 is a screen print of a detailed loan display.

FIG. 7 is an enlarged view of a Loan Level assessment.

FIG. 8 is an enlarged view of a workflow application panel.

FIG. 9 is a a screen print showing a configurable case allocation screen.

FIG. 10 is a screen print of a New User Registration screen.

FIG. 11 is a screen print of an exemplary dashboard.

FIG. 12 is a screen print of an Authority Level Entry screen.

FIG. 13 is a screen print of a populated an Authority Level Entry screen for a user who has been given access to the Securitization workflow,

FIG. 14 is a screen print of the User Access Control entry screen.

FIG. 15 is a screen print of the User Designation Setup.

FIG. 16 is a screen print list of previously created setup rules.

FIG. 17 is a screen print of the User Designation Rule Setup Screen.

FIG. 17 is a screen print showing a Configurable Case Allocation Screen.

FIG. 18 is a screen print of the Round Robin User Selection pop-up screen.

FIG. 19 is a screen shot of a populated Round Robin User Selection screen.

FIG. 20 is a screenshot of the graphical work-flow for the template-based document generator, about to generate a demand letter.

FIG. 21 is a screenshot of a management dashboard available for overall departmental management of loans.

FIG. 22 is a screenshot illustrating composition of an exemplary workflow for attachment to a document.

FIG. 23 is a screenshot illustrating the document manager by which any document can be selected, and any workflow attached to it.

FIG. 24 is a composite view of the Task Management Interface.

### DETAILED DESCRIPTION OF THE PREFERRED EMBODIMENTS

The present invention is a software solution for comprehensive workflow management in an office environment. The software may be deployed in a variety of office settings, including healthcare providers, law offices, accounting offices, etc. For purposes of illustration, the software is herein described in the context of a default loan workflow management solution.

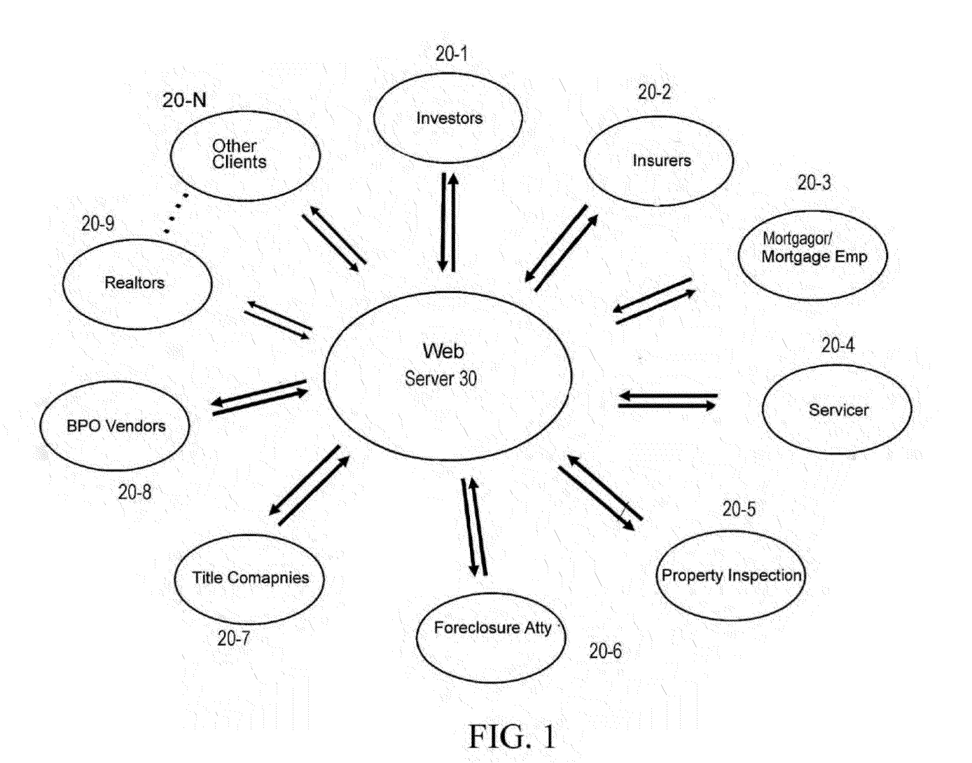

FIG. 1 illustrates the various participants involved in default loan servicing practice management, including: the Investors, Loan Insurer, the Mortgage Company (Lender) and its Employees, a Mortgagor/Borrower, Foreclosure Attorney, a Title Company, business process outsourcing (BPO) Vendors, Realtors, Property Inspection Companies and Servicers such as neutral/oversight organizations such as HopeNow™ offering debt management, credit counseling and overall foreclosure counseling, and the US Treasury (collectively, “the Participants”). The present invention provides an ecosystem in the form of a software and hardware platform for simultaneous participation of all the foregoing Participants. The system facilitates dialogue, guides and educates the participants through a defined Case Management Process, and tracks activity and provides information necessary for a speedier resolution.

System Hardware

The system relies on a hardware foundation comprising a hub-and-spoke web-based client/server architecture, and a software foundation comprising an open-architecture modular array of web-based software for data exchange with the various participants and the various third party applications used by those participants.

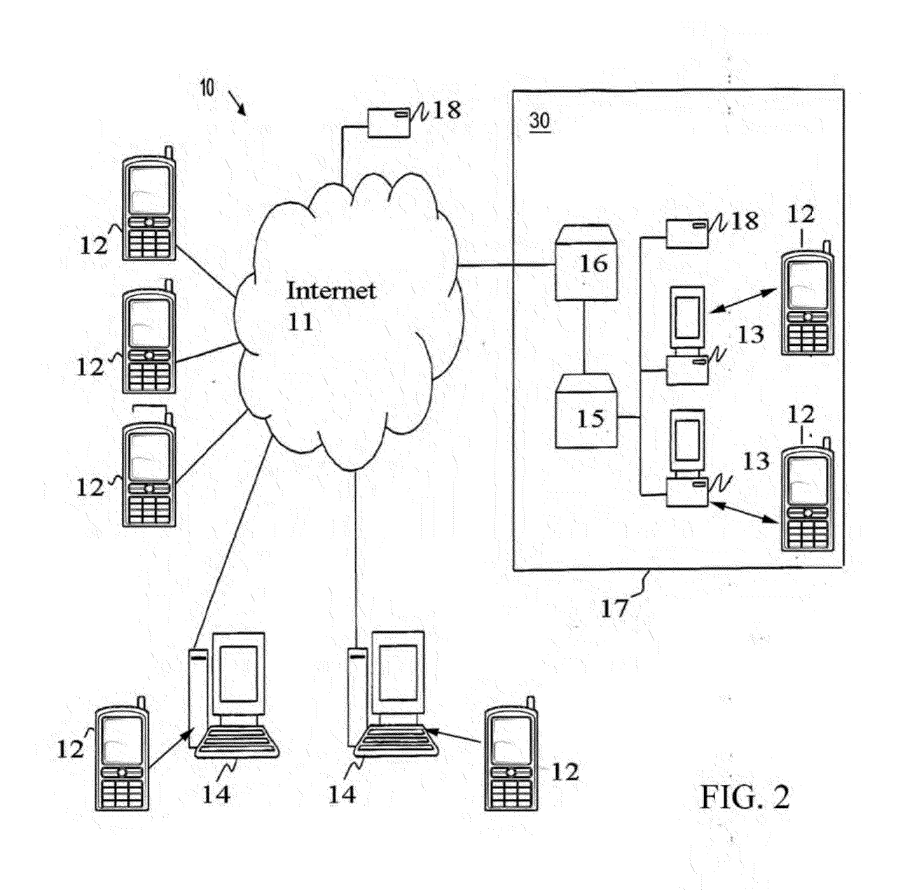

FIG. 2 is an illustration of the harware architecture which is a distributed hub-and-spoke client server hardware architecture. At the participant level, the service is delivered through a plurality of Client Communications Terminals 20-1 (clients) through 20-N (here nine). Each Client Communications Terminal 20-1-9 is a conventional computer workstation with sufficient processing power to deliver a rich mix of audio, video, graphics, documents, and data. Groups of clients 20 are connected to a Network Server 30 via an internet backbone. The Server 30 is a web-enabled server hosting a resident routing database, which stores data authentication and verification information (usernames and passwords) correlating to registered participants.

A URL-based (uniform resource locator) web portal is established for each of the Participants, and each client 20 is provided access to their own assigned web portal by which they access the present software resident on Server 30. The software comprises a modular array of open-architecture software configured specifically for each participant and user, that provides all the essential tools for that participant to communicate with other participants, manage each case for the day-to-day work scheduling, tracking, document generation, communication with office tools, smooth integration with the standard business software, emailing, scanning, faxing, etc. The particular modularity ensures open architecture and allows adding, upgrading and swapping of both hardware and software components. All of the client side computer stations 20-1 . . . N are in network connection to the central server 30, and all of the participant software modules are in communication with a central module that facilitates the overall workflow and data exchange. All Server 30 communication connections are made through an Internet backbone using a conventional router, using industry standard protocols such as the Transmission Control Protocol/Internet Protocol (“TCP/IP”), File Transfer Protocol (FTP), HTTPS, DiCOM, etc.

In addition, a hierarchical permissions scheme is assigned including administrator and individual users permissions. The Participants use one or more client side computer stations for accessing their assigned web portal. The web portal includes hyperlinks to a plurality of index-tabbed webpages each including content for guiding the respective participants through all of the default loan Case Management Process. In addition to this workflow guidance, the participants also have access (through their web portals and based on the permissions scheme) to the server-hosted software modules which facilitate data exchange amongst the various participants, as well as the various third party applications used by those participants.

A specific example is disclosed in which the practice management system is applied to default mortgage cases, and includes day-to-day work scheduling, tracking, document generation, communication with office tools, smooth integration with the existing business software, emailing, scanning, faxing, and a single-sign on capability to access other third party software's, sites, and web applications.

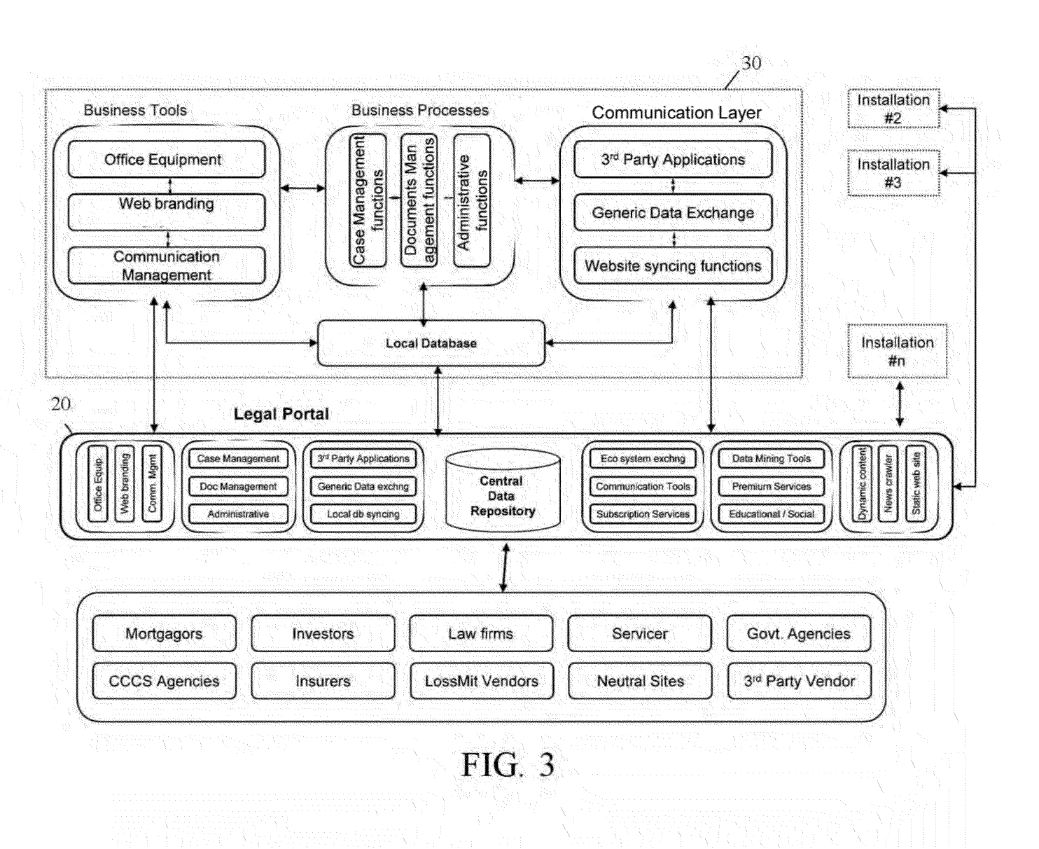

FIG. 3 is a more detailed schematic diagram of the software architecture, including architecture and communication flow. The entire software architecture is modular and relies on Business Tools Layer, Business Process Layer, and a Communication Layer to facilitate the data inputs and outputs amongst the various participants. Each business typically relies on Business Tools such as office equipment, web branding, communication tools, etc. They implement Business Processes during which they use the Business Tools, such as Case Management, Document Functions, and Administrative Functions. During those Business Processes communications take place such as data communications with 3^{rd} party software applications, generic data exchange, and website synchronization. The present software implements these three functions as three distinct layers and integrates them in a server environment 30 as seen in FIG. 3. The software may be deployed on a local network for use in a local environment (Enterprise edition) or as centrally hosted repository (SaaS; Software as a Service edition). This way, the Server Environment 30 is capable of supporting most any internal business process. The Server Environment 30 is in communication with a centralized Portal Environment 20. As stated above with respect to FIG. 2 each client 20 is provided access to their own assigned web portal by which they access the present software resident on Server 30.

In a SaaS deployment the Communication Layer, Business Tools, and Business Process Modules remain physically resident on the Server 30 of FIG. 2 but are accessable by each client 20 via the internet. In addition, the Server 30 maintains a local database of case-specific loan information including records of each Mortgagor's personal and financial information, and all three Communication Layer, Business Tools, and Business Processes Modules may access this database.

The Communication Layer mirrors all or part of the Server 30 database to a local database or Central Data Repository on each of the participant's stations 20-1 . . . n, and each of the participant's stations 20 may access the Communication Layer, Business Tools, and Business Processes Modules as shown by arrows via their assigned web portal. The Communication Layer further comprises a plurality of communications interfaces, including interfaces to third party applications, a generic data exhcnage interface, and website syncing functions for accomplishing the above-described mirroring of the Server 30 database to a local database or Central Data Repository on each of the participant's stations 20-1 . . . n. The website syncing functions also allow branding of each of the participants portals with their own trademarks and copyrighted content. The interfaces to third party applications comprise standard EDI functions for porting data in a user-controlled manner from third party software to the Server 30 database, e.g., a data-inport translation map. The generic data exchange accomplishes data exchange amongst the various participant clients 20-1 . . . n based on the participant identity and permissions granted. For example, the Property Inspection company 20-5 of FIG. 2 does not need to have access to the entire contents of the Server 30 local database, and so the generic data exchange controls the data that can be exchanged to each of the participants based on their permissions.

The Business Tools Module on Server 30 further comprises a networked array of office equipment including at least a network copier, scanner and fax machine. The Business Tools Module further comprises a Communications Management module (to be described) which essentially includes the original equipment drivers supplied by the office equipment manufacturers and management software for implementing those drivers on demand. In addition, the Business Tools Module includes a web branding module which is essentially a website content manager by which the various participant modules can be branded with the logos, trademarks, copyrighted content, etc. of each respective participant.

The Business Processes Module on Server 30 further comprises an array of case-specific Case Management Functions, an array of Document Management Functions, and an array of Administrative Functions as will be described.

All of the Communication Layer, Business Tools, and Business Process Modules and all of their sub-modules resident on the Server 30 are accessible by each of the participant clients 20-1 . . . n (as seen mirrored therein) subject to that user's permissions.

As seen at right the foregoing architecture is fully scalable.

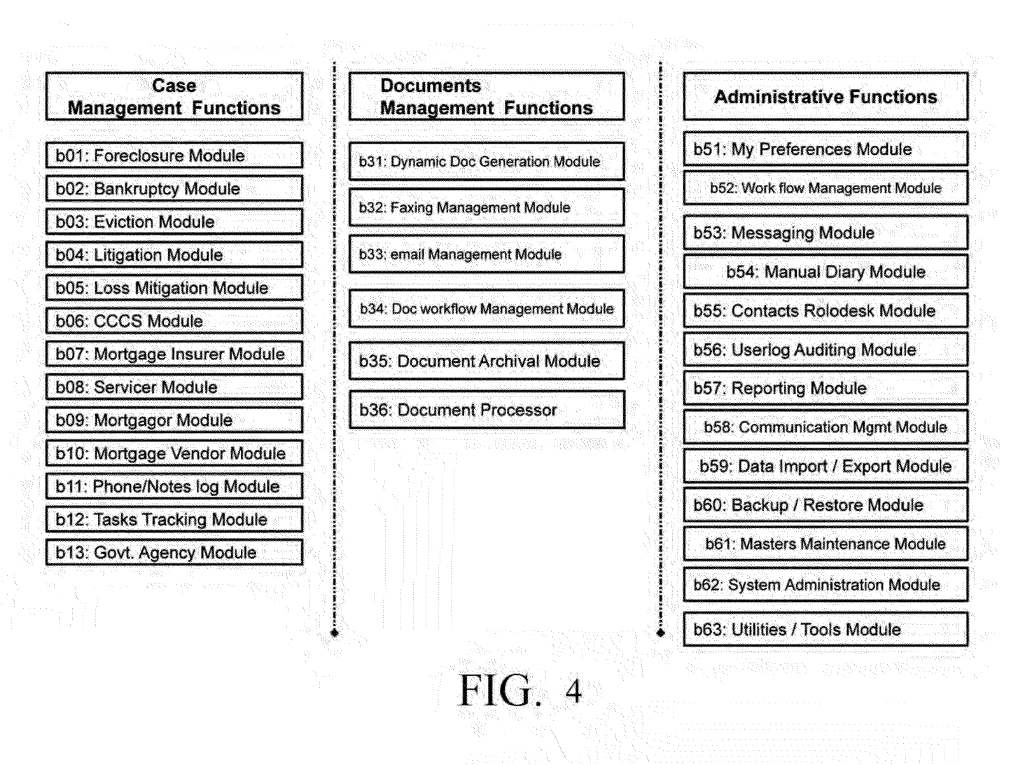

FIG. 4 is an itemization of the different sub-modules of the Business Process Module required for the legal forclosure-oriented practice. In the exemplary legal context, the Business Processes illustrated at center includes all Management Functions, Accounting Functions and Administrative Functions made available to employees or the Participants by the present software. These Business Processes include at least the following software sub-modules:

Case Management Functions

b1: Foreclosure Module
b2: Bankruptcy Module
b3: Eviction Module
b4: Litigation Module
b5: Loss Mitigation Module
b6: CCCS Module
b7: Mortgage Insurer Module
b8: Servicer Module
b9: Mortgagor Module
b10: Mortgage Vendor Module
b11: Phone/Notes log Module
b12: Task Tracking Module
b13: Govt. Agency Module (Audit/Oversight Module)

Document Management Functions

b31: Dynamic document Generation Module
b32: Faxing Management Module
b33: email Management Module
b34: Document workflow Management Module
b35: Document Archival Module
a. Document Indexing
   b36: Document Processor
a. Document publication

### Administrative Functions

b51: My Preferences Module
b52: Work flow Management Module
b53: Secured Messaging Module
b54: Manual Diary Module
b55: Contacts Rolodesk Module
b56: Userlog Auditing Module
b57: Reporting Module
b58: Communication Management Module
b59: Data Import/Export Module
b60: Backup/Restore Module
b61: Masters Maintenance Module
b62: System Administration Module
b63: Utilities/Tools Module

The Foreclosure Module (b1) guides the user through administration of a foreclosure action, including data entry of salient data gained through the process.

The Bankruptcy Module (b2) guides the user through administering a bankruptcy action, including data entry.

The Eviction Module (b3) guides the user through administering an eviction proceeding, including data entry.

The Litigation Module (b4) guides the user through a civil court action against the mortgagor, including data entry.

The Loss Mitigation Module (b5) guides the user through a loss mitigation settlement. For example, Loss Mitigation Module (b5) will by a series of displayed forms guide a loan counselor through a series of questions to be asked of a borrower all relating to various loss mitigation solutions, various borrower reasons for not repaying a loan, and provides a data entry capability for recording answers.

The CCCS Module (b6) guides a consumer credit counseling service user through the work flow of providing consumer credit counseling to a defaulted mortgagor, likewise with data entry.

All of the data entry results from above are filtered and communicated back the Central Data Repository as described above, and all major reminders, deadlines and other events (past and future) for the loan in default are compiled and passed back to to the above-described modules to populate the screens displayed to the particpants.

The different sub-modules of the Business Process Module also include administrative functions for allowing adminstrators to control document processing and workflow. These include the Dynamic Document Generation Module (b31), a Faxing Management Module (b32), an email Management Module (b33), a Document workflow Management Module (b34), a Document Archival Module (b35), a document indexing submodule (b35a), and document publication submodule (b36a).

In addition, the different sub-modules of the Business Process Module also include administrative functions for allowing users and adminstrators to set preferences, view reports, and access administrative tools such as contact manager (eRolodex) and calendar. These include the My Preferences Module (b51), the Work flow Management Module (b52), the Phone/Notes log Module (b53), the Manual Diary Module (b54), the Contacts Rolodesk Module (b55), the Userlog Auditing Module (b56), the Mortgage Insurer Module (b07), the Reporting Module (b57), the Servicer Module (b08), the Human Resources Module (b58), the Debtor/Mortgagor Module (b09), the Data Import/Export Module (b59), Mortgage Vendor Module (b10), Backup/Restore Module (b60), Reporting Module (b11), Masters Maintenance Module (b61), Tasks Tracking Module (b12), System Administration Module (b62), Case Billing Module (b13), and a Utilities/Tools Module (b63).

The My Preferences Module (b51) allows individual users to set individual display preferences similar to a Microsoft™ Windows environment.

The Work flow Management Module (b52) allows customization of the workflow implemented by any of the above-described modules b1-b6.

The Phone/Notes log Module (b53) provides a simple on-screen call log with notes function.

The Manual Diary Module (b54) allows a user to record their efforts working on a given case.

The Contacts Rolodesk Module (b55) provides a contact manager.

The Userlog Auditing Module (b56) allows an administrator to inspect a log of users for auditing purposes.

The Mortgage Insurer Module (b07) provides a portal to provate mortgage insurers such as Freddie Mac, Fannie Mae, FHA/HUD, VA, and private mortgage insurers.

The Reporting Module (b58) provides pre-defined as well as fully customizable reports displaying relavant information by loan number, date, etc. These reports may be printed to hard copy.

The Servicer Module (b08) provides a portal to third party loan servicers.

The Human Resources Module (b58) provides a portal for participant human resource managers.

The Debtor/Mortgagor Module (b09) provides a web portal for the mortgagees (borrowers) by which they can view their own case financials and communicate.

The Data Import/Export Module (b59) provides a data import/export capability on demand for importing data, for example, to/from spreadsheets, etc.

The Mortgage Vendor Module (b10) provides a portal for the mortagor (lender).

The Backup/Restore Module (b60) provides a control function for backing up and/or restoring database data.

The Masters Maintenance Module (b61) provides a portal for court-appointed special masters.

The Tasks Tracking Module (b12) tracks the entire spectrum of defaulted-loan servicing activities, from collections through foreclosure on the same processing platform, as that on which resides the applications to perform these activities, is not known to exist.

The System Administration Module (b62) provides global administrator settings, including user permissions.

The Case Billing Module (b13) provides a recording tool for inputting case billing information.

The Utilities/Tools Module (b63) provides a variety of data utilities as a matter of design choice.

The above-described modules and sub-modules are selectively made available to all the participants based on administrator-defined permissions, and the modules collectively provide each participant all the essential tools to manage their workflow. In default mortgage cases, the system facilitates all communication, guides and tracks the participants through day-to-day work scheduling, tracking, document generation, communication with office tools, smooth integration with the existing business software, emailing, scanning, faxing, and a single-sign on capability to access other third party software's, sites, and web applications. The web-based application allows for easy secure access and all the data sharing and connectivity abilities between all participants to the workout.

All of the foregoing modules and sub-modules resident on the Server 30 are accessible via a web-based “Dashboard” application presented to each of the participant clients 20-1 . . . n subject to that user's permissions.

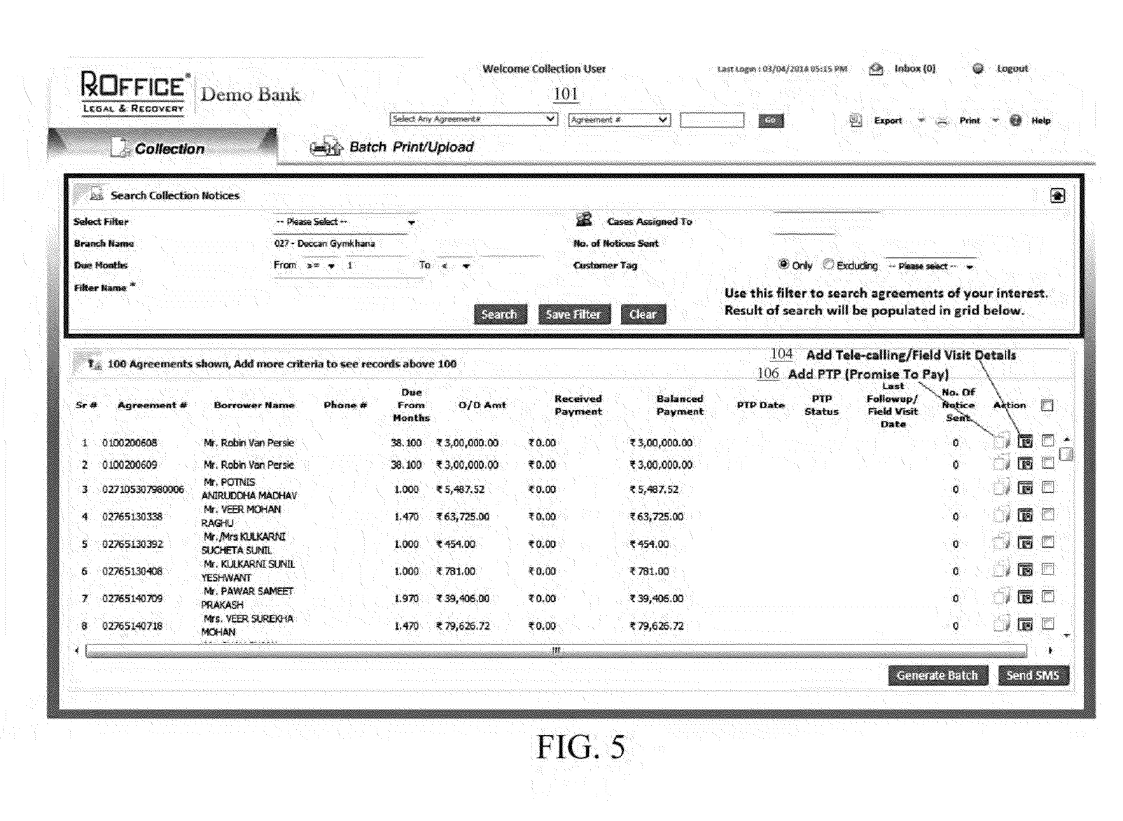

FIG. 5 is a screenshot of an exemplary operational dashboard available to the various participant clients 20-1 . . . n based on the participant identity and permissions granted. The example is a collection dashboard. A selection filter 101 appears across the top to allow selection of loans by number. In addition, a custom filter array 102 is aligned across the top to screen/filter agreements for collection, e.g., displaying loans that meet user-specified criteria or pre-defined filters such as “Today”, “Pending” and “Future” filters. The user can select a pre-defined filter at “Select Filter” and/or populate the fields below to filter loans by Branch Name, Months Overdue, Assigned Agent, Number of Notices Sent, and/or Customer Tags. Once these fields are populated a new Filter Name can be assigned and hitting “Save Filter” will store that custom filter for later use, the assigned name thereafter appearing in the drop-down “Select Filter” list. Hitting “Search” will filter only those loans meeting the user-specified or pre-defined filter criteria such as, for example, loans scheduled for action today, pending or any other user-specified filter. The loans selected by the combined filters 101, 102 are displayed in a columnar format by Agreement #, Borrower Name, Phone #, Months Overdue, Overdue Amount, Received Amount, Balance Due, Promise to Pay (PTP) Date, PTP Status, Last Follow-up, and Notices Sent To the right of these two action buttons 104, 106 appear. Action button 106 instantiates a “Promise to Pay” data entry screen by which the user can enter information relating to any promises to pay exacted from the debtor. Action button is a “Field Visit Data Entry” button that instantiates a data entry screen by which the user can enter information relating to any actual field visit made by the user with the debtor. Using this Operator Dashboard a collection agent can take any desired action on any desired loan.

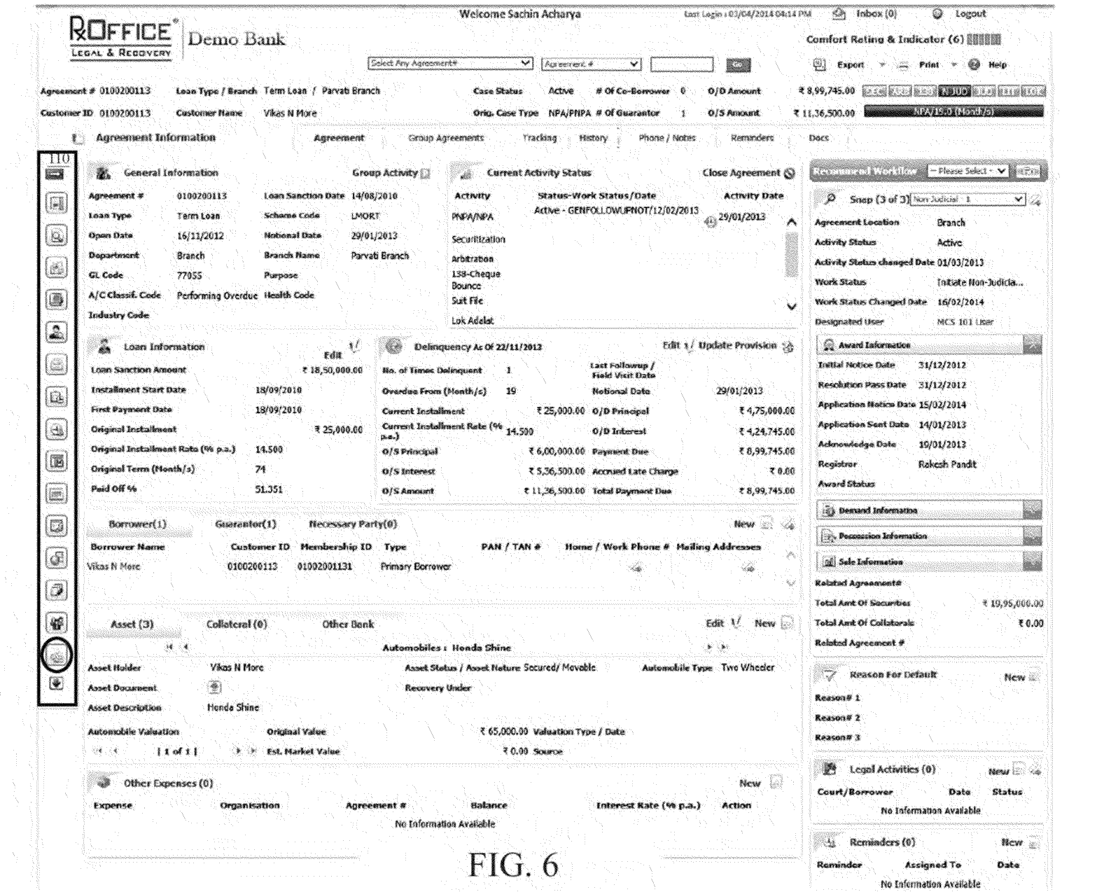

Clicking on a specific loan engenders extremely detailed loan information displayed in a single-page format, as shown in FIG. 6.

By clicking on the Group Agreements button of FIG. 6, the user can accomplish account clubbing. This is important if the borrower maintains multiple different loan accounts with the bank. (e.g. home loan account, Car loan, etc). The law requires summing up of all the loan balances and raising the demand on the clubbed amount. The Group Agreements functionality display all related loan accounts in the FIG. 6 and allows a planned work-flow to be executed on each “clubbed” collection of related loans.

As seen at mid-screen of FIG. 6, all the necessary parties to a loan are displayed and may be investigated from this single view, e.g., “Borrower”, “Guarantor” and other “Necessary Parties”. Below that, an Asset Management window display all information on the secured assets and allows the user to add in additional assets which were not considered during the loan origination process.

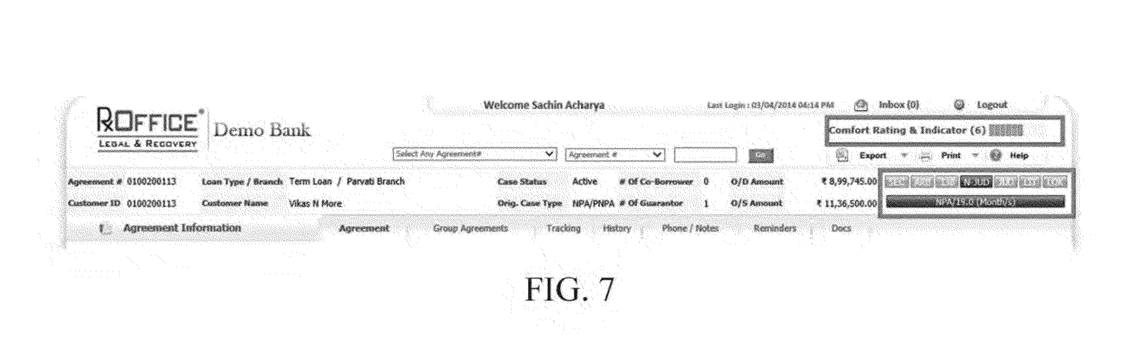

One of the more robust loan management features of the detailed loan information screen of FIG. 6 is the Loan Level Assessment appearing at top right. The Loan Level Assessment is enlarged in FIG. 7, and this gives the user a consolidated view of the stage of the collection process for the selected loan, the duration of non-performing status, and an overall comfort rating designed to provide a summary rating of the collection process. The “comfort rating” is a client-configurable calculator for deriving a “comfort rating” for instant comparison. In the illustrated case the calculator is set to a default setting in which it uses the difference between the total debt and the valuation of the secured assets as follows:

X=sum of secured amount of all loans of customer;
Y=sum of outstanding amount of all loans of customer

### Calculator Rules:

1. If x>=y then comfort indicator shows green color with rating 10
2. If x=0 then comfort indicator shows red color with rating 0
3. If x<y,

Z=(X/Y)*10 gives us comfort rating indicator

The present invention includes a currency translation system that provides for the dynamic translation of currency into a target currency value (Indian Rupee shown) for the purpose of allowing international collection efforts. Each user's Operational Dashboard target currency reflects the country/currency of their local address. The system maintains a database of currency rates, conversion rules and formatting of into a presentation specific to the locale of the user.

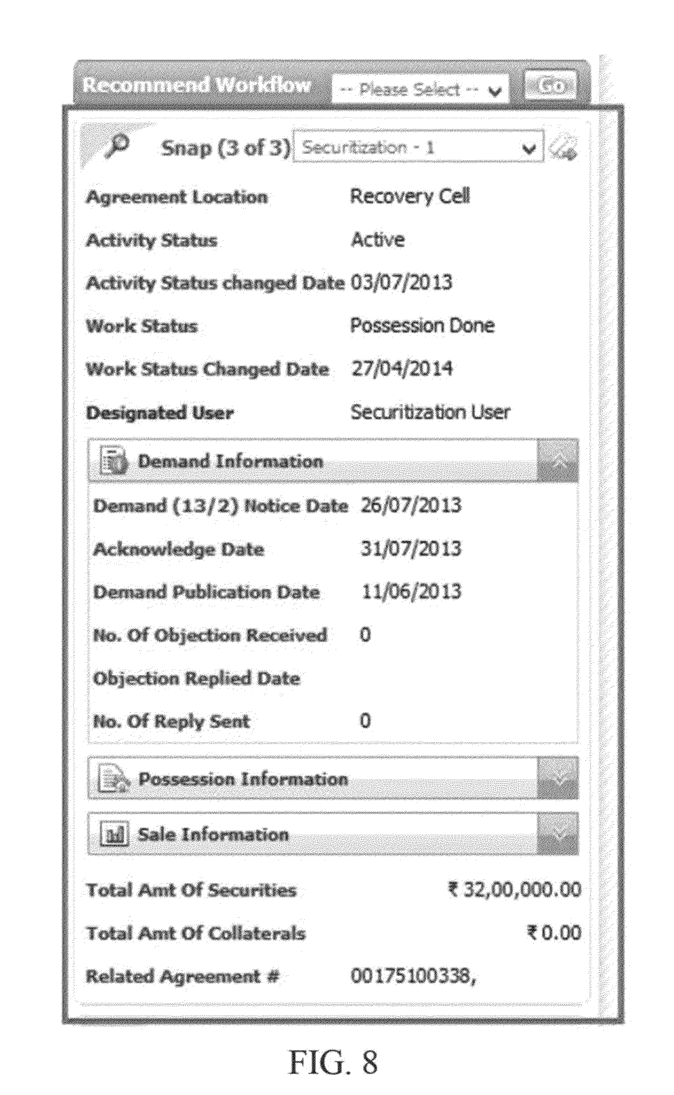

The Operational Dashboard (FIG. 5) including its detailed loan information screen (FIG. 6) allows the user to apply one or more prescribed workflow(s) to any user, loan, document, or group of the foregoing. As seen at the far right mid-section of the detailed loan information screen of FIG. 6 the user can select a prescribed workflow and apply it to a selected object (here a loan). This workflow application panel is enlarged in FIG. 8, and this gives the user a consolidated view of the stage of the applied workflow. The present system employs a WorkFlow Management Module that automatically coordinates the workflow among all involved workgroups and entities involved in the loan collection process. This Workflow Management Module is described in detail below.

The present system also includes a template-based document generator including a user-interface for creating templates containing a plurality of variable fields with formatting attributes. The variable fields are populated by data values associated with the variable field. The templates are created in a WYSIWYG environment, such as Microsoft® Word or Open Office, and are populated with data in PHP. The resulting document can be saved not only to PDF, but also DOCX, DOC and RTF. The document generator is multilingual, and calls upon a heuristic NLG library responsive to the variable data which provides a sequenced organization of phrase structure for expressing the variable data based on the content extracted.

Using the a template-based document generator, and referring back to FIG. 6, the user can generate and send notices pursuant to the prescribed workflow, and monitor the results.

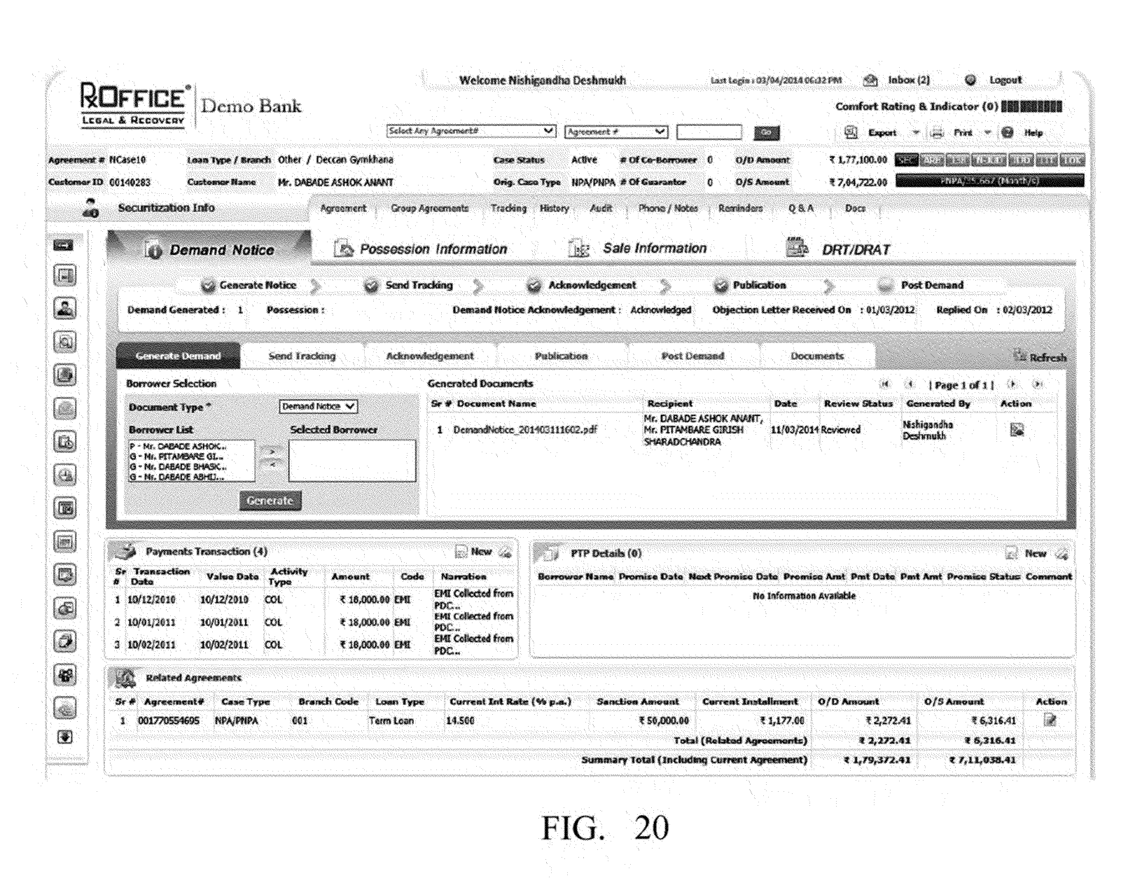

FIG. 20 is a screenshot of the graphical work-flow for the template-based document generator, about to generate a demand letter. Correspondences generated during the collection process are represented by index tabs at top: demand; tracking; acknowledgement; publication; post demand. Each such piece of correspondence generated during the collection process can be generated here, by selection of one or more borrower(s) as addressees, and selection of a document type. A listing of previously-sent documents is also given. Emails as well as documents can be composed and sent by SMS, to single debtors or group. This facilitates bulk collection with batch notice generation.

Clicking the next index tab to the right (Possession Information) gives information on the assets held during the recovery process and on those who hold them.

Clicking the next index tab to the right (Sale Information) gives information on the sale of assets held during the recovery process, including auction minimum bid, actual bid and other information relevant to a sale.

Finally, clicking the next index tab to the right (DRT/DRAT) gives information on pending judicial processes, here identified as Debt Recovery Appellate Tribunal (DRAT) and/or Debt Recovery Tribunal (DRT) processes as appropriate under India's laws. This section largely automates case handling. In this or any of the foregoing sections documets can be uploaded from local disk storage for archiving.

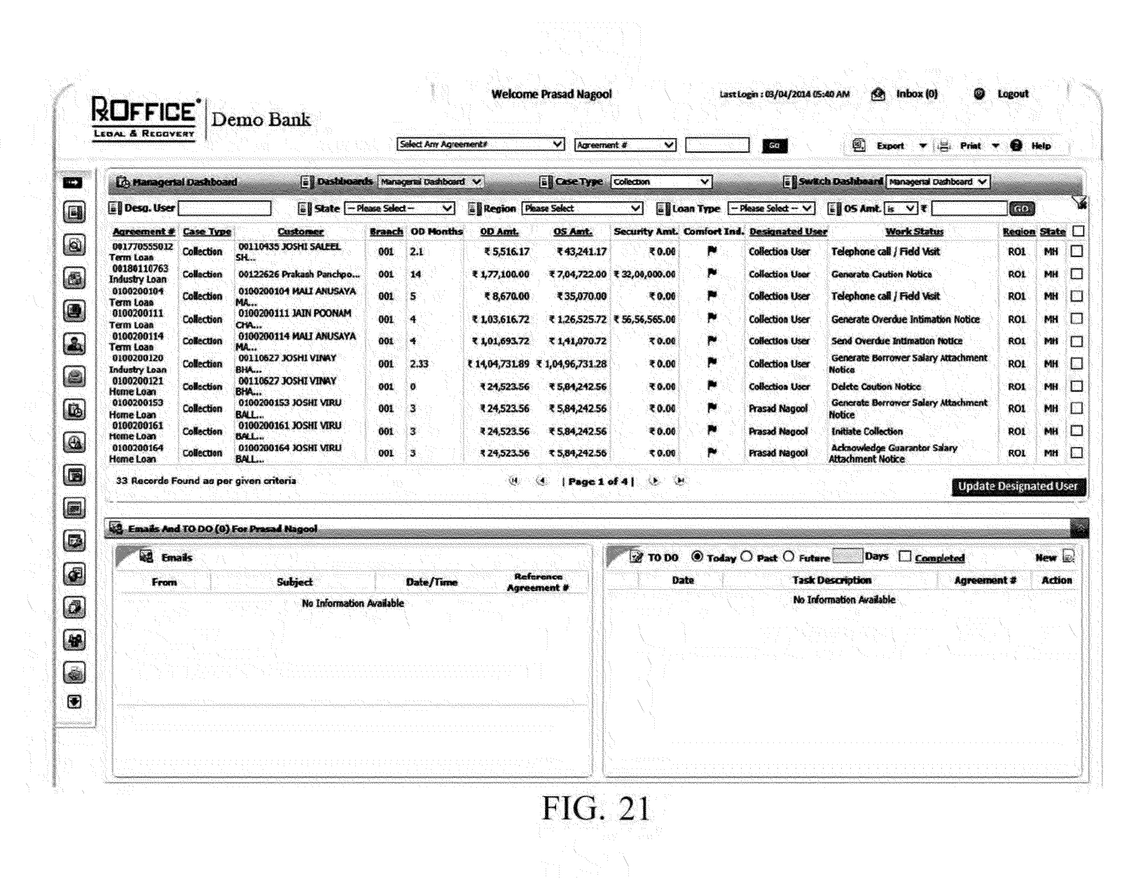

In addition to the operational dashboard, FIG. 21 is a screenshot of a management dashboard available for overall departmental management of loans. The Management dashboard provides filters as described previously plus user-related filters such as User, State, Region, OS Amount, and Custom filters. This allows a manager to review loan details and/or performance metrics for individual users, or groups of users. The loan details include Agreement Number, Case Type, Customer, breach, Overdue Months, Overdue Amount, OS Amount, Security Amount, Comfort Index, Designated User, Work Status, User, and State. An email pane and to-do list at bottom right and left, respectively, show emails and task items assigned to the selected users or groups of users.

WorkFlow Management Module

The steps and rules that define an organization's workflow are customized according to the workflow requirements and process steps for each organization. The WorkFlow Management Module allows a predefined sequence of application steps to be attached to any user, loan, document, or group of the foregoing, and processed simultaneously by various entities involved in the loan application process. Each completed step of the applied workflow is scheduled automatically and tracked for completion. Importantly, task assignment is accomplished using a Round-robin (RR) algorithm. Time slices are assigned to each process in equal portions and in circular order, such that all tasks per workflow are assigned without priority. As in real life, tasks can be performed by various people. Work groups/departments manage their assigned task when a loan/file reaches that stage and the loan/file gets passed to next group/department when current group/dept finishes their assigned activities. The present system allows creation of dynamic work-groups, with members/employees dynamically assigned to the group. When a group/dept finishes their assigned activities and a loan/file is passed to next group/department, the work is automatically assigned in round-robin fashion to a member of the receiving group. By default the group members are viewed equally during round-robin work assignment. However, a supervisor, on occasion, can intervene and re-assign work to different individuals using override features. In this manner, each user/employee get tasks (as appropriate) to work on and as soon as their assigned task in complete, work-flow management feature moves the loan/file to next task (may be in the same group or different group as the case may be).

In an embodiment, multiple tasks may be assigned and multiple work-flows run at same time. In this situation workflows may be prioritized such that a priority task blocks another lower-priority task when two conflict. The round-robin work assignment process begins by allocating defined users a defined workflow and restricting their geographies. Then work assignments are automatically allocated by round-robin assignments to the proper users during as case files are initially uploaded from third-party client database(s). will be described in more detail with regard to FIGS. 15-16 below.

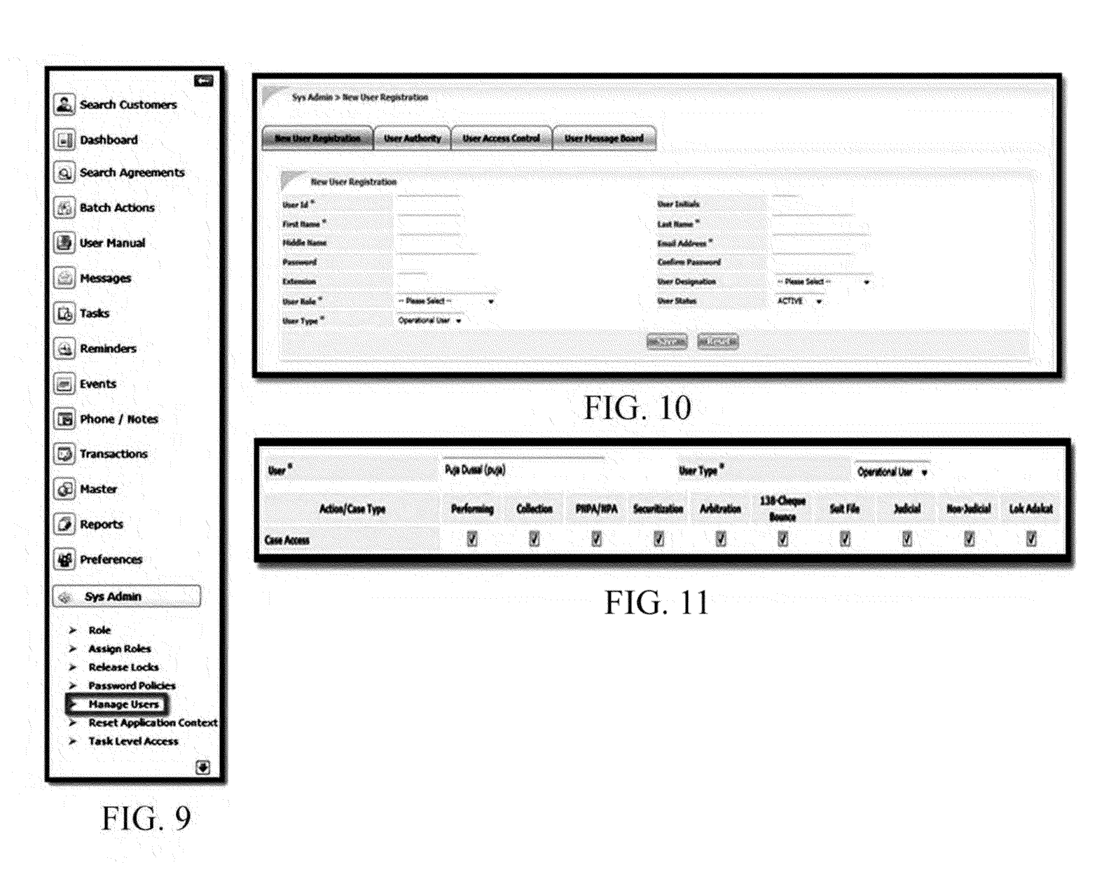

However, it is first necessary to understand how new users are created and for this we refer briefly back to FIG. 6. A menu side bar 110 is shown at far left which provides one-click access to many of the system functionalities. This side bar 110 can be expanded and collapsed by clicking the topmost icon. One of the slide bar icons (circled in FIG. 6) accesses a drop-down System Administration Menu as shown in FIG. 9. One of the drop-down options in the System Administration Menu of FIG. 9 is “New User Creation”. A system administrator clicks on this option to create a new user. A New User Registration screen appears, as shown in FIG. 10. The user details are entered, including User Id, User Initials, First Name, Last Name, Middle Initial, Email Address, Phone Extension, User Designation, User Role, User Type, User Status, etc. By this screen a new user may be created and registered.

The next tab shown in FIG. 10 sets User Authority. This initiates the entry screen of FIG. 11, where the system administrator can select workflows to be accessible to the new user. By simple check-boxes, the new user can be designated as having access to one or more defined case types. The system administrator selects the user name from the drop-down list (created in new user registration), and designates one or more case types from all the types of workflows possible, e.g., Collection, PNPA/NPA, Securitization, arbitration, etc. By selecting the check box in the Case Access row against defined workflows the designated user is given access to that work flow. For example, if a user is working at any branch on Collection Cases, by checking Collection in the User Authority screen the designated user is given access to collection cases. The new user can have access to one or more workflows and, as illustrated, the user has access to all the defined workflows. This simple check-box interface allows convenient selection of all appropriate authorities for each new user.

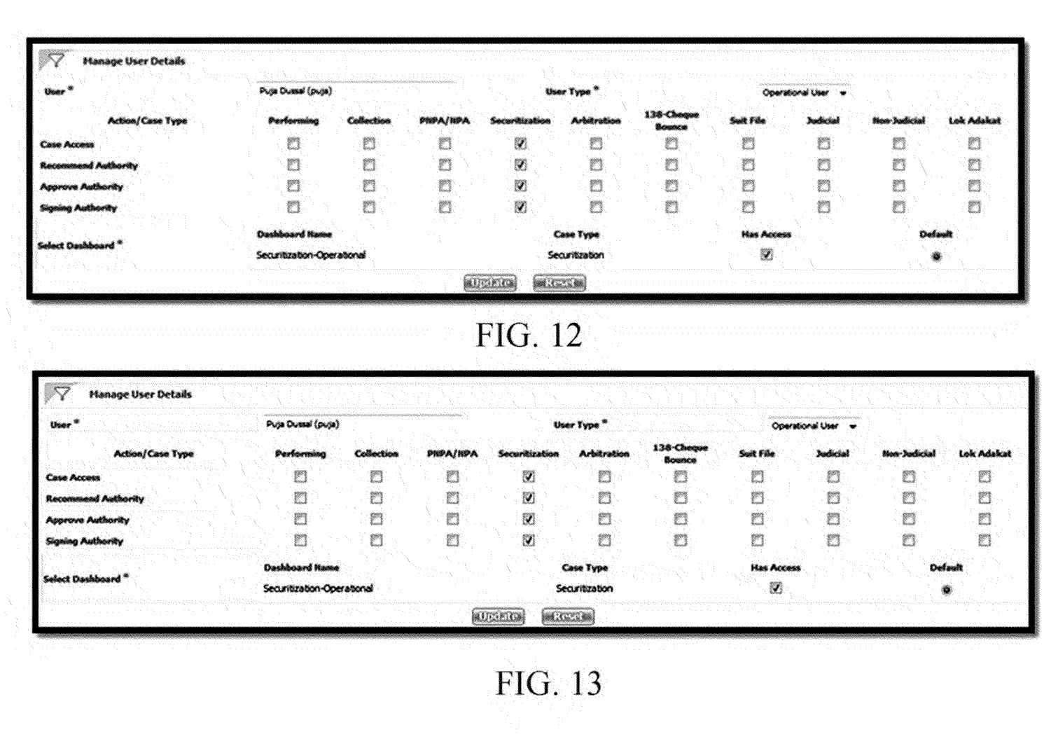

The system administrator may also assign different Authority Levels to the user for each selected workflow. By selecting a check box in the Case Access row above, a user Authority Level Entry screen appears as shown in FIG. 12. This allows selection of user authorities within each workflow the designated user is given access to. There can be different authorities for each workflow. As seen in FIG. 12 exemplary user Authority

Levels include: Recommend, Approve and Sign as follows.

a. Recommend Authority: One who can recommend a workflow

b. Approve Authority: One who has authority to approve a recommendation received.

c. Signing Authority: One has authority to sign on notices to be dispatched in that workflow.

By checking one or more Authority Levels in the User Authority Level screen the designated user is given authority to perform these workflow tasks. This simple check-box interface allows convenient selection of all appropriate authority levels for each new user.

By way of example, FIG. 13 illustrates a user who has been given access to the Securitization workflow, wherein the user can recommend Securitization, Approve recommendation received for Securitization, and Sign on notice dispatched in Securitization workflow.

For every workflow a dedicated user operational Dashboard exists such as the Collection Dashboard shown in FIG. 5. If access to a workflow is given as per above, then the system administrator is forced to allocate one Dashboard. This is shown at the bottom of FIGS. 12-13 where one Dashboard, e.g., the Securitization Dashboard, is selected. The system administrator must select dashboard(s) to be presented to the user and at least one operational dashboards is assigned by default (the default dashboard is displayed to the user by default upon login). After selecting the foregoing details the system administrator clicks on Save. At this point, the system administrator has created a user, assigned him workflows, defined authorities, and assigned the user's dashboard.

Referring back to FIG. 10 the third tab over allows setting of User Access Control.

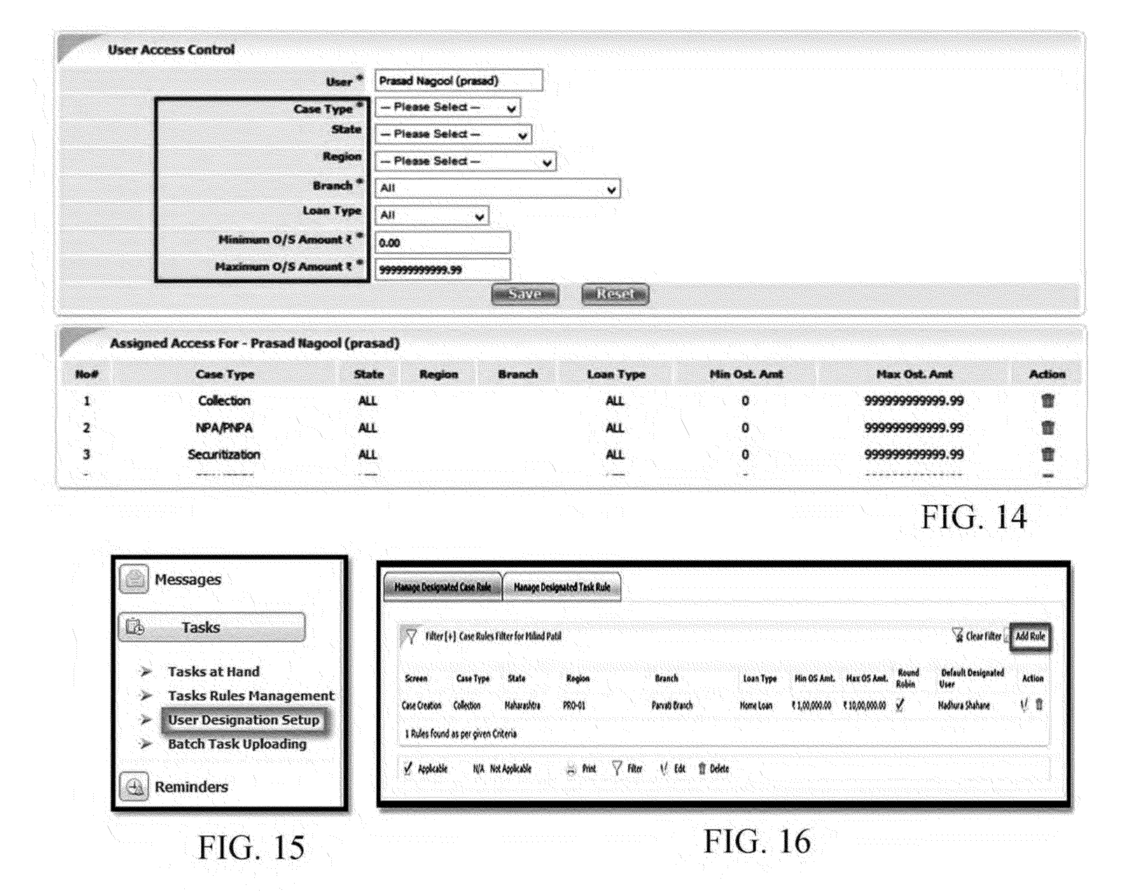

FIG. 14 is a screen print of the User Access Control entry screen. This is a configurable user-access management screen that allows selection of users that will handle the case from users who have access (from the Case Allocation screen). Access can be given using different combinations as per client requirements. The following are the parameters which can be combined together to define access.

a. Workflow

b. State

c. Region

d. Branch

e. Loan Type

f. Min/Max O/S Amount (Outstanding amount)

The User Access Control entry screen restricts user access to loan accounts depending on the section (branch/regional office/state) in which the user is working, the workflow the user works on, the type of loans user can handle, and amount limits. From the User Access Control entry screen of FIG. 14 the system administrator: 1) selects the name of user from the user list at top; 2) selects the workflow for which access is to be given (second line); and 3) if the user is responsible for monitoring all accounts in selected workflow for a particular state, then the name of state is selected from the state list (line 3). If the user is a regional user, then nothing is selected from the State list and instead the appropriate region name is sleeted from the region list (line 4). For example, if a user is responsible for Ohio then Ohio is selected from the state list (line 3), but if the user is responsible for the Midwest region then Midwest is selected from the region list (line 4). Depending on the state/region selection, the branches under them will be populated in the Branch list (line 5). If no region/state is selected, all the branches will be listed in Branch List. If a user is responsible for a particular branch then there is no need to select state/region, and only the branch need be selected from branch list (line 5).

Line 6 is the Loan Type selector by which the administrator can select a loan type and thereby contain the loan type that the user can handle, e.g. Home loan, Car loan, etc.

Line 7 allows selection/limitation of the range of Out Standing amount the user may handle. This way, loan files involving large balances may be specially allocated to select users.

If a user has not given access to particular workflow from this screen, he will not be able to access the workflow in snapshot as well as detail workflow. For example, when a loan is seriously delinquent, property valuation analysis need to be performed along with the legal action readiness process. During this initial verification if it is discovered that property is abandoned by the borrower then securing property and protecting asset gets high priority than performing analytics and performing other checklists. Given the foregoing system administrator creation of a user, assignment of workflows, defined authorities, assignment of the user's dashboard, and setting of user access control, the system administrator proceeds to User Designation Setup. This is accessible from the side bar 110 of FIG. 6, and more specifically from the Task Icon shown in FIG. 9. Clicking the Task Icon presents the drop-down menu of FIG. 15, which includes the User Designation Setup. This menu is used to manage automatic loan account allocation to different users. The User Designation Rule Setup Screen allows definition of different criteria, for e.g., a workflow in which a loan account is loaded into the system, state/region/branch in which loan account belongs, type of loan, and oustanding balance range. The system administrator may select the appropriate criteria as per requirement. By way of example, to create a rule for a loan account of type Home loan, in Collection workflow of Parvati branch with outstanding balance amount in the range of $10M to $100M.

The User Designation Setup screen configures the group of users to whom the loan account is allocated. Selecting User Designation Setup from Tasks menu on slidebar (FIG. 15) displays a list of previously created setup rules (FIG. 16). Clicking on the Add Rule link on the right hand side opens a new screen to create user designation rules.

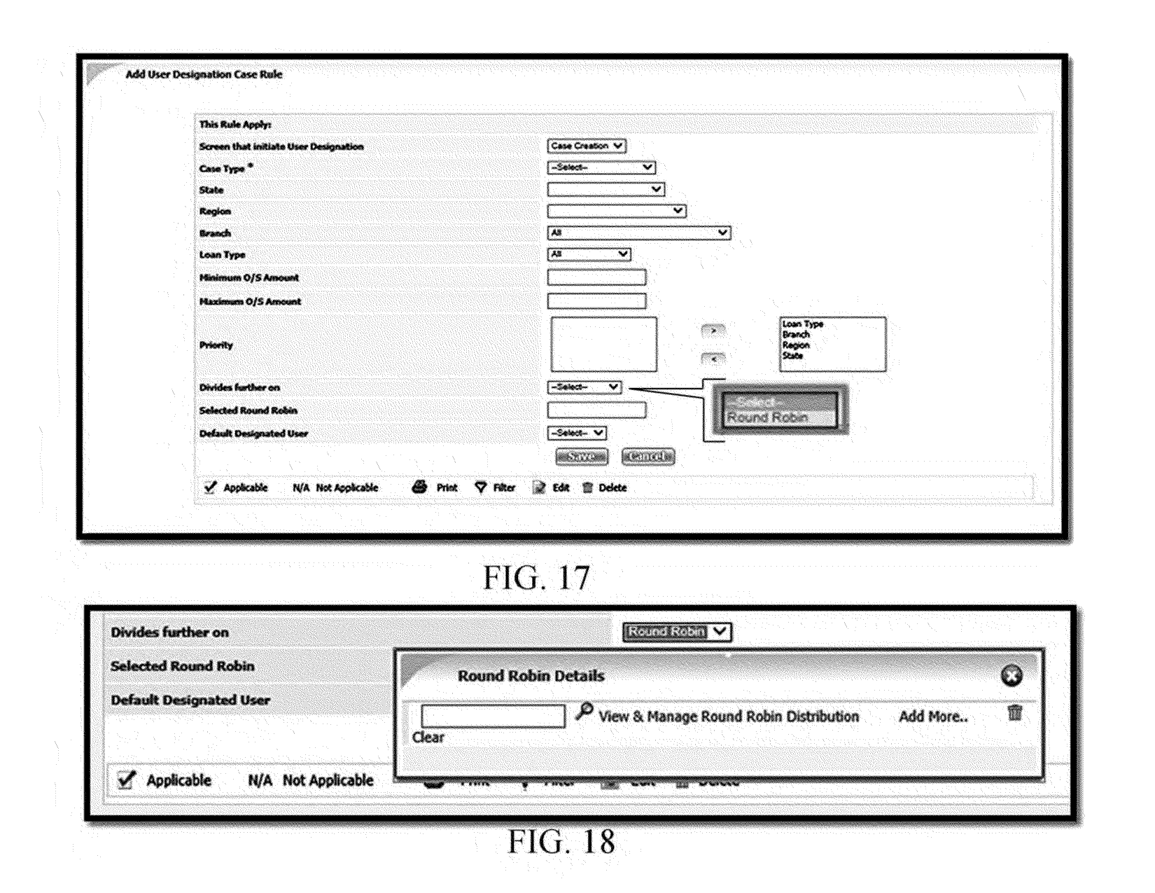

FIG. 17 is a a screen print showing a Configurable Case Allocation Screen. This screen allows the system administrator to define allocation configuration for distributing cases to users. The cases can be allocated based on below parameters:

a. Workflow (case type)

b. State

c. Region

d. Branch

e. Loan Type

f. MM/Max O/S Amount (Outstanding amount)

Additionally the allocation also can be done based on a Round Robin algorithm. To do this, the system administrator may click on the field “Divides Further On” (FIG. 17) and select the Round Robin option from the dropdown menu (see inset). This opens a new Round Robin pop-up (FIG. 18) by which a new user group can be created, or to select a previously-created user group.

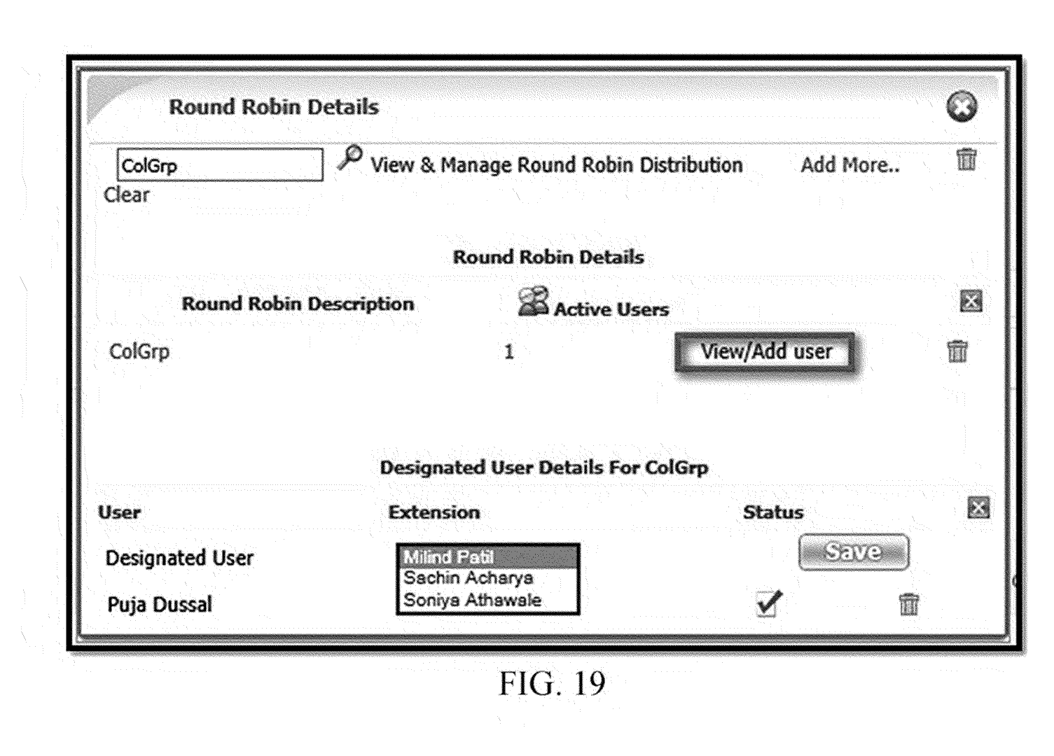

FIG. 18 is a screen print of the Round Robin User Selection pop-up screen. To view previously-created groups, the system administrator clicks on “View and Manage Round Robin Distribution.” To create a new group, the system administrator clicks on the “Add More” link. This presents a list of users that are eligible for selected criteria. The system administrator enters a Group name, selects users to add in group, and clicks on Save. To add more users into a group, click on View/Add User link against the group name. The user list is populated only with users who have been given access in the preceding steps (user creation, authority, allocation). The system administrator simply selects authorized users and clicks on Save. Once a user group is completed, the system administrator may create a new group name and select it for rule creation (as described above) and click on Save. FIG. 19 is a screen shot of a populated Round Robin User Selection screen.

The next step is to select the group of users to whom the loan account satisfying above criteria (from User Designation Rule Setup Screen) will be allocated. This is accomplished using the Default Designated User selection of FIG. 17.

After selecting the user group and select the default designated user and clicking on save, the rule is created successfully. Now whenever a loan account satisfies the selected criteria for the rule, that loan account will be allocated to the users in the created Group in a Round Robin Manner. Given the foregoing selections the allocation preferably occurs immediately upon loan on-boarding (of loan files from client databases). Thus, as soon as new loan account is loaded into the system, it is allocated to the user(s).

In addition, the present system includes a calendar-organizer for displaying the foregoing task assignments in conventional calendar format.

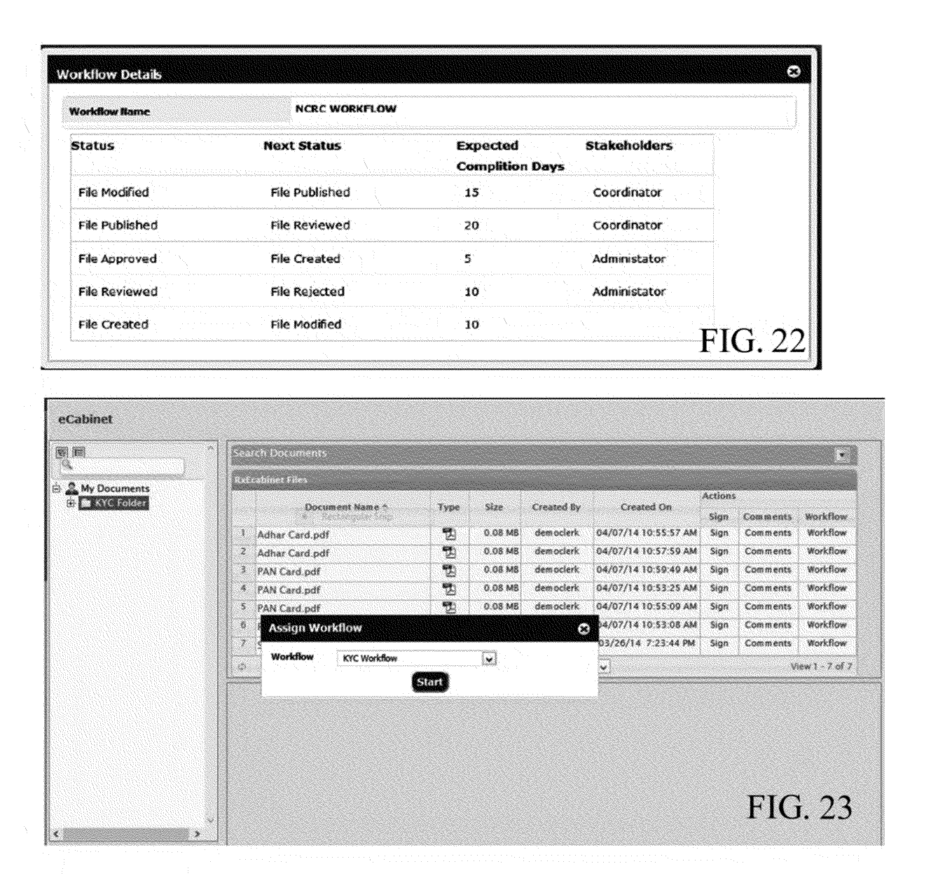

FIG. 22 is a screenshot illustrating composition of an exemplary workflow for attachment to a document. A workflow may comprise any sequence of individual tasks, task-schedules, and task-assignments. For example, a document-related workflow may define a transmission path between users for document flow, as well as any sequence of tasks and task-assignments to user(s) during the flow. Thus, this NCRC workflow includes five operational steps to be performed on a document and defines each step in terms of Status, Next Status, Expected Completion Days, and Stakeholders. Once the workflow steps are defined the workflow can be attached to a document as shown in FIG. 23. The system provides a windows-explorer-type document manager by which any document can be selected, and any workflow attached to it as shown. Alternatively, a workflow can be attached to any workgroup, individual user or company. Prioritized multiple work-flows may be run at the same time, and higher-priority workflows may block other lower-priority work-flows.

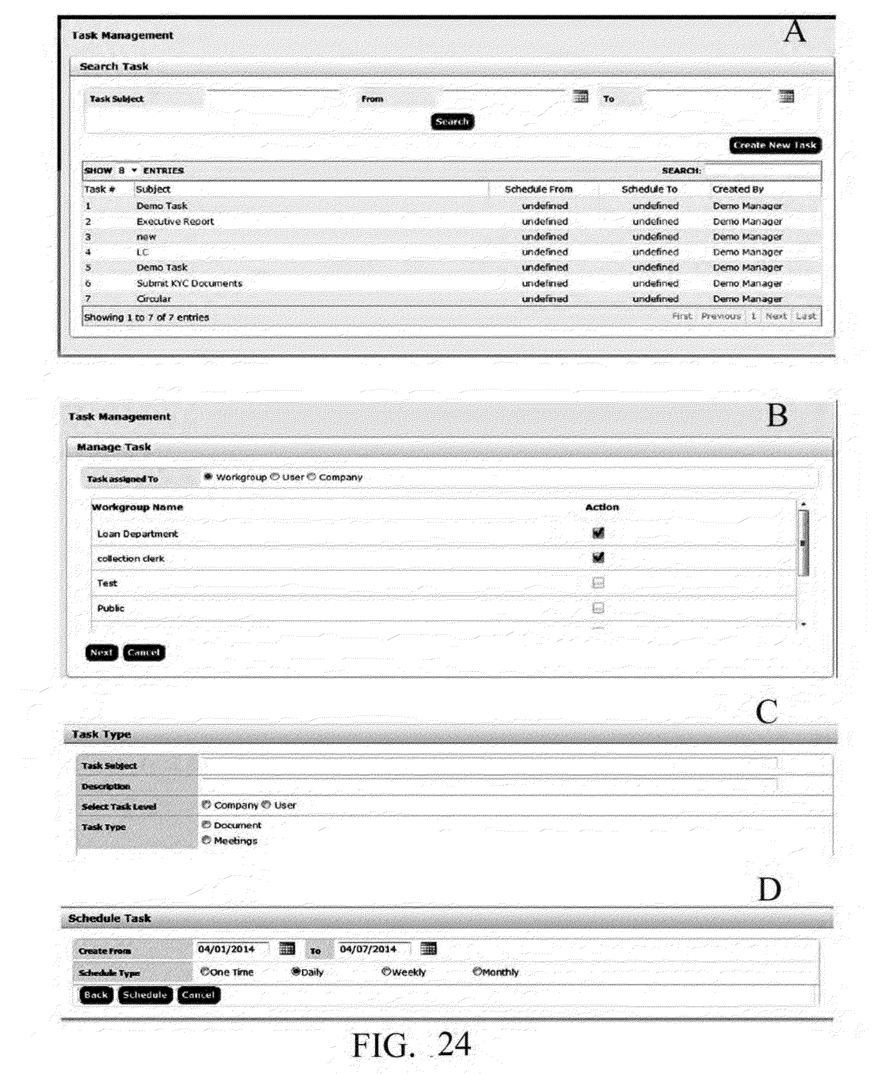

The system provides a Task Management Interface for defining and managing individual tasks. FIG. 24 is a composite view of the Task Management Interface. At FIG. 24(A) a general list of predefined tasks is shown. At FIG. 24(B) each task can be assigned to a defined workgroup or company (and job titles within that workgroup/company checked or not as shown), or individual user. As seen at FIG. 24(C) the task type may be defined as a document-related task, or user-related task such as a meeting. Finally, as seen at FIG. 24(D) the task may be scheduled.

Lead Consolidation and CRM

The present system also incorporates a turnkey Customer Relationship Management (CRM) module for lead follow up and communication. The CRM module is capable of aggregating and scrubbing customer leads from multiple Lead sources into a computer database, each marketing lead record in the database including at least consumer name, address, telephone number and email address. During scrubbing dupes are eliminated, the integrity of the lead data is checked, and phone numbers are screened against do-not-call-lists.

It should now be apparent that the above-described business practice management system manages communications and workflow in an integrated fashion, has the flexibility to be implemented with a wide variety of other business practices, is easily adaptable to changes in needs of business practices, and can be delivered to the business practice without requiring investment in equipment or products. In the default loan context, the system facilitates information gathering, integration, and analysis, and leads to the culimination of a guideline-compliant loan workout that mitigates losses to all effected parties. Specifically the system facilitates the simultaneous endeavors of continuous workout efforts and expedient foreclosure processing by all participants, while providing unique, high-level and detailed loan-level views of the servicing activities so that all parties to various concurrent processes are apprised of the loan status in real-time. While doing this the system tracks the entire spectrum of defaulted-loan servicing activities, from collections through foreclosure on the same processing platform, as that on which resides the applications to perform these activities. The system essentially provides a computer ecosystem for maintaining a healthy business environment (healthy margins, happy clients and employees and willing suppliers with a established name and credibility to the business).

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A business practice management system, comprising:
a hub-and-spoke web-based client/server architecture including a plurality of remote client terminals, one client terminal for each primary participant in a default mortgage case, and a web server in direct communication with all of said client terminals through an Internet backbone;
a URL web portal assigned to each of said participants, said web portal including links to a plurality of index-tabbed webpages each including content for guiding the respective participants through all of the default loan resolution steps of collection, loss mitigation, foreclosure, eviction, bankruptcy, claims, REO acquisition and maintenance, and REO disposition;
a modular array of web-based software resident on said web server for data exchange with the various participants and the various third party applications used by those participants that facilitates dialogue, guides and educates the participants, tracks activity, and provides information necessary for a speedier resolution, said modular array including a workflow management module for defining an object comprising a chronological sequence of tasks, whereby said object may be attached to any user, loan, document, or group of the foregoing.
